(19) United States
(12) Patent Application Publication
(10) Pub. No.: US 2018/0111736 A1
(43) Pub. Date: Apr. 26, 2018

(54) SEALING LID HAVING PATTERNED ADHESIVE

(71) Applicant: True Label, Inc., Toledo, OH (US)

(72) Inventors: Robert E. Napierala, II, Sylvania, OH (US); Jeremiah P. Michael, Haskins, OH (US)

(73) Assignee: True Label, Inc., Toledo, OH (US)

(21) Appl. No.: 15/850,536

(22) Filed: Dec. 21, 2017

Related U.S. Application Data
(62) Division of application No. 14/820,853, filed on Aug. 7, 2015.
Application No. 14/820,853 is a continuation-in-part of application No. 13/527,240, filed on Jun. 19, 2012, now abandoned.
(60) Provisional application No. 61/498,759, filed on Jun. 20, 2011.

(51) Int. Cl. B65D 75/32; B32B 7/12; B32B 3/16; B32B 37/12; B32B 1/00; A61J 1/03

(52) U.S. Cl. CPC B65D 75/327; B32B 2439/40; B32B 7/12; A61J 1/035; B32B 37/12; B32B 1/00; B32B 3/16

(57) ABSTRACT

A blank for sealing a tray having one or more compartments includes a face stock with a pressure sensitive adhesive pattern which closely matches the top surface area of the tray, excluding the tray compartment areas. The pattern may be precisely formed with the pressure sensitive adhesive containing a coloring or fluorescing agent. The adhesive forms an identifiable registration mark used for properly aligning the adhesive pattern for die cutting the face stock in a specific location in relationship to the pattern. Various types of sensors may be used to identify the registration mark. Alternatively, the pattern may be precisely formed by printing a blocking or deadening agent in a pattern that contains a sensor mark with a blocking or deadening agent that contains a coloring or fluorescing agent, onto a flood coated pressure sensitive adhesive. This pattern forms an identifiable registration mark that is used to properly align the blank for cutting the face stock in a specific location in relationship to the adhesive pattern.

### CROSS-REFERENCE TO RELATED APPLICATIONS

This application is a division of U.S. application Ser. No. 14/820,853, filed Aug. 7, 2015, which is a continuation-in-part of U.S. application Ser. No. 13/527,240, filed Jun. 19, 2012, and claims the benefit of U.S. Provisional Application No. 61/498,759, filed Jun. 20, 2011, the disclosure of which is incorporated herein by reference.

### FIELD OF THE INVENTION

This invention relates generally to lids for sealing packages having compartments. In particular, this invention relates to lids having patterned adhesive for sealing such packages and to methods of manufacturing such lids.

### BACKGROUND OF THE INVENTION

Blister packages are commonly used for packaging pills and other products. Blister packs typically have a tray with one or more compartments for containing the products. A heat seal cover is typically adhered to the top surface of the tray to seal the products within the compartments until needed. Heat activates the adhesive in the non-compartment areas of the package securing the lid to the blister package.

In the past, a package lid would be coated entirely with a heat-activated adhesive and applied to the top surface of the tray, the adhesive attaching to the entire surface area of the tray except in the areas of the compartments. Unfortunately, the heat-activated adhesive creates a bond that cannot be removed and therefore the product within the compartment must be pushed through the lid. This requires a certain level of strength that makes it difficult for some individuals to punch the product through the lid in order to remove it from the compartments. Until now, pressure-sensitive adhesives have not been a viable option, as a process had not been developed to apply an adhesive in a pattern that can be properly die cut so that when applied to the blister pack, the adhesive is not coated on the lidding over the areas that contain the product. It would be undesirable and harmful for many products, such as pills, foods, etc. if portions of the lid, which covered the compartments, were coated with a pressure sensitive adhesive that could come in contact with the goods packaged in the container.

One method of preventing pressure sensitive adhesive from contacting goods packaged in such containers is to provide an adhesive pattern on the lid to match the top surface of the tray. Because of the pattern complexity and the limited surface area of the tray, it is difficult to properly register a lid with a tray to assure that the adhesive will be in the correct location spaced from the tray compartment openings. A system for locating the pressure sensitive adhesive pattern for proper positioning of a lid on a tray is needed.

### SUMMARY OF THE INVENTION

One aspect of the present invention is a lid for sealing a package, the package including a tray having one or more compartments. The lid has a face stock with an active pressure sensitive adhesive pattern that closely matches the top surface area of the tray, excluding the tray compartment areas. The adhesive pattern may be formed by applying adhesive in a pattern, or by applying an adhesive block or deadening agent in a pattern to portions of a pre-coated pressure sensitive adhesive on the back of a roll of face stock to create the pattern. Regardless of whether the pattern is created by applying the adhesive in a pattern or the pattern is created by using a blocking or deadening agent and applying it in a pattern to portions of a pre-coated pressure sensitive adhesive, both methods will use a coloring or fluorescing or other agent to allow the pattern to be identified on the roll and detectable by a sensor. The adhesive or deadening agent is patterned in a method that creates a registration mark used for precisely die cutting the face stock in relationship to the pattern. The registration mark is detectable by a sensor. Various types of pressure-sensitive, permanent, removable and repositionable adhesives and sensors may be used.

In another aspect of the invention, a registration mark can be printed and used for precisely cutting a liner covering the adhesive in a pattern corresponding to the tray compartments and then registering the die blank to the pattern. As the lid is applied to the tray, the liner is removed except for the portions that correspond to the tray compartments. The remaining portions of the liner isolate the compartment contents from coming in contact with the adhesive.

Various additional aspects of this invention will become apparent to those skilled in the art from the following detailed description of the preferred embodiments.

### BRIEF DESCRIPTION OF THE DRAWINGS

FIG. 1 is an exploded perspective view of a package including a sealing lid made in accordance with the present invention.

FIG. 2 is cross-sectional view of a sealing lid made in accordance with the present invention.

FIG. 3 is a plan view of the sealing lid taken along line 3-3 of FIG. 2.

FIG. 4 is a plan view of a pattern adhesive sealing lid blank of the present invention, with the crosshatched areas indicating adhesive.

FIG. 5 is a plan view of a pattern adhesive sealing lid blank of the present invention with the crosshatched areas indicating adhesive.

FIG. 5A is a schematic view of a die cutting process of the present invention.

FIG. 5B is a plan view of an alternative patterned adhesive sealing lid blank of the present invention with the crosshatched areas indicating adhesive.

FIG. 6 is a cross-sectional view of an alternative sealing lid made in accordance with the present invention.

FIG. 7 is a plan view of a sealing lid of FIG. 6 prior to removal of the liner.

FIG. 8 a cross-sectional view of another alternative sealing lid made in accordance with the present invention.

FIG. 9 is a plan view of the sealing lid of FIG. 8.

### DETAILED DESCRIPTION OF THE PREFERRED EMBODIMENTS

### The Sealing Lid

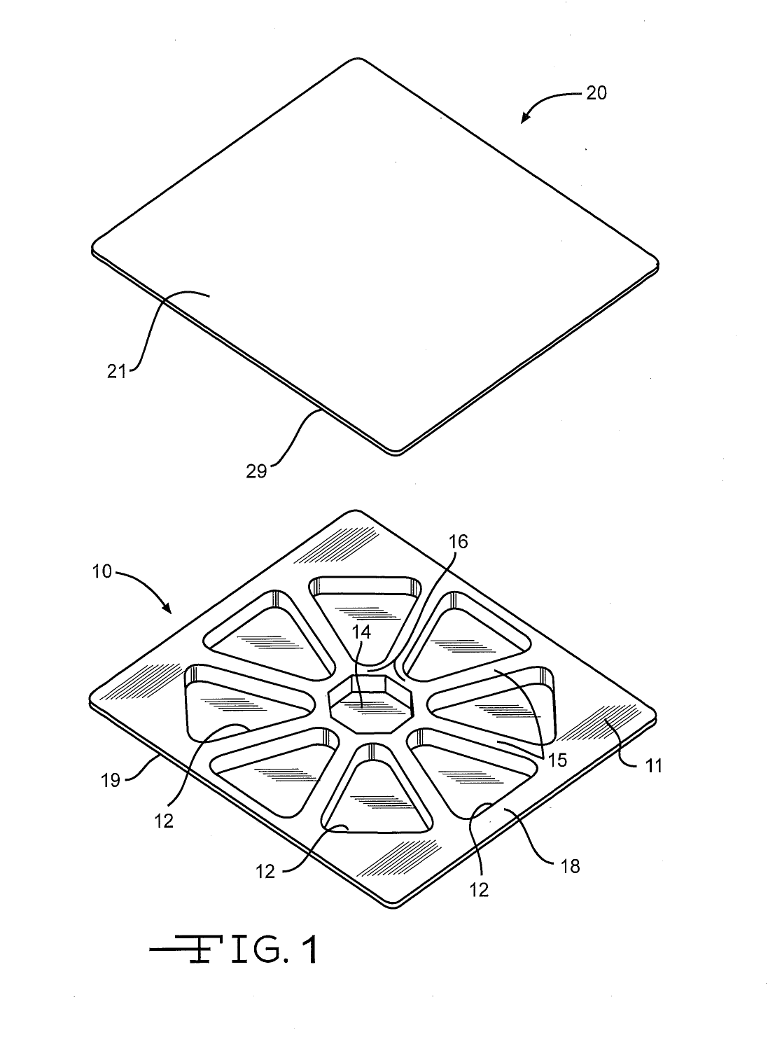

Referring to FIG. 1, a package includes a body or tray 10 and a sealing lid 20 made in accordance with the present invention. The lid is also a label on which information may be printed, such as contents, medical information, etc. The tray 10 is a conventional polymer blister-type package for receiving and containing products such as pills, food, etc. The tray 10 has a generally flat upper or top surface 11 and one or more compartments 12. In the illustrated embodiment, the tray 10 includes eight generally triangular-shaped compartments 12 an octagonal central indentation 14. Of course, the present invention is applicable to trays of various shapes and sizes and any number of compartments of various shapes and sizes.

The illustrated tray 10 has a relatively complex pattern of compartments to demonstrate the complexity of the problems addressed by the present invention. The upper surface 11 includes generally radially extending ribs 15 between next adjacent compartments 12. Generally circumferentially extending ribs 16 extend between the indentation 14 and the compartments 12. An outer peripheral region 18 extends between the compartments 12 and the outer periphery 19 of the tray 10.

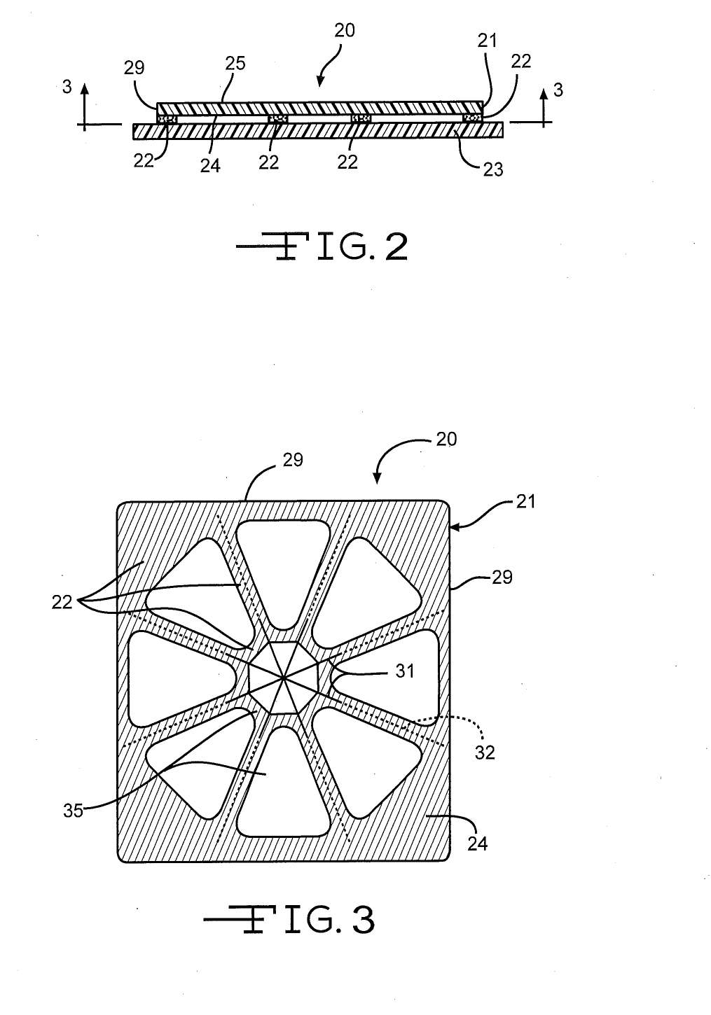

Referring to FIG. 2, the lid 20 is shown on a silicone coated release liner 23 prior to being applied to the tray 10. Typically, identical lids such as 20 are provided on a liner 23 in a roll to facilitate automated application of lids 20 to trays 10. The lid 20 includes a face stock 21 and an adhesive 22. The face stock 21 has an inner or bottom surface 24 and outer or top surface 25. The face stock 21 has an outer periphery or edge 29 shaped and sized to substantially match the outer periphery 19 of the tray 10. The liner 23 is slightly wider than the face stock 21. The outer periphery 29 of the face stock 21 has been cut to size as will be described herein.

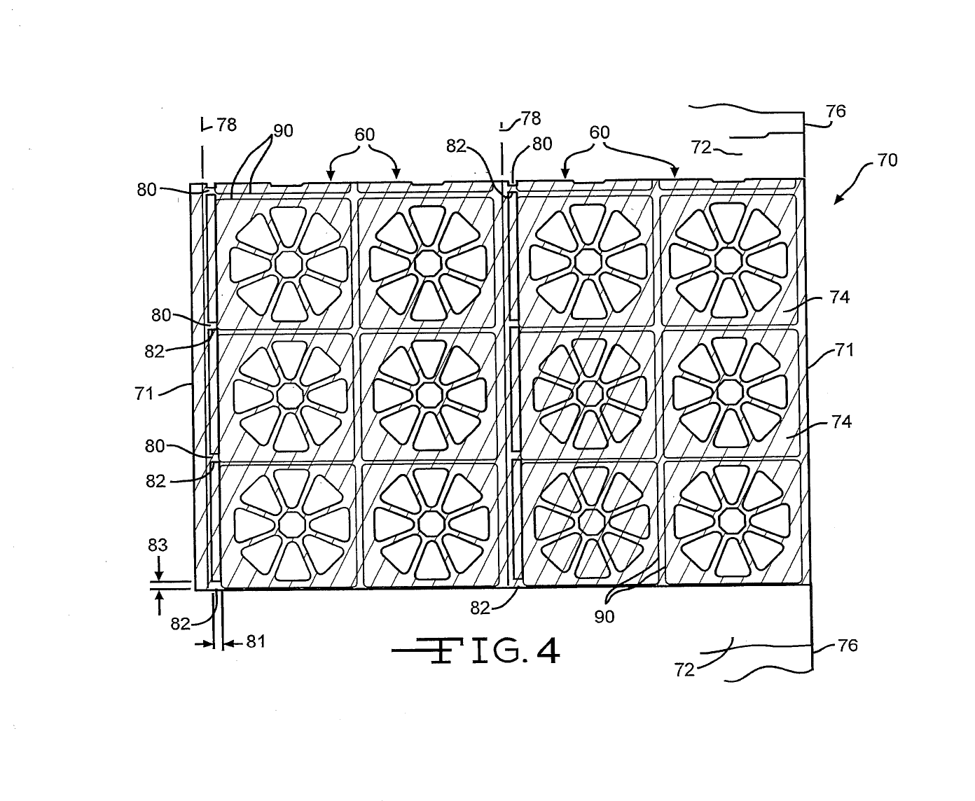

Referring to FIG. 3, the adhesive 22 has been applied to the bottom surface 24 of the face stock 21 in a pattern, which corresponds to the top surface 11 of the tray 10. Specifically, in the illustrated embodiment, the adhesive pattern corresponds to the tray ribs 15, 16 and outer peripheral area 18 of FIG. 1. The adhesive 22 does not cover the areas corresponding to the tray compartments 12 and the indentation 14 in FIG. 1.

In this particular embodiment, the face stock 21 has perforation lines 32 in a pattern corresponding to the tray compartments 12. Specifically, the face stock 21 includes radially extending cuts or slits 31, each of which extend from the center of the lid approximately one-quarter of the radial distance to the face stock edge 29. The face stock 21 also includes radially extending perforation lines 32, each of which extends from a radially outer end of a slit 31 to a point adjacent the face stock edge 29. The slits 31 and perforation lines 32 are made by a die cutting machine, as is well known in the art, to provide removable tabs 35, one corresponding to each compartment 12 of the tray 10. The tabs 35 may be removed one at a time to provide access to the individual tray compartments 12. Slit lines and perforation lines can be a various dimensions and locations within the lid 20 depending on the size and shape of the tray 10. Optionally, the face stock may have no cuts so as to be removed in one piece. If the adhesive used is a repositionable adhesive, it can be lifted off of the tray 10 to remove the desired product and then re-attached to the tray 10 to keep any remaining product in individual compartments for later removal.

### Manufacture of the Sealing Lid

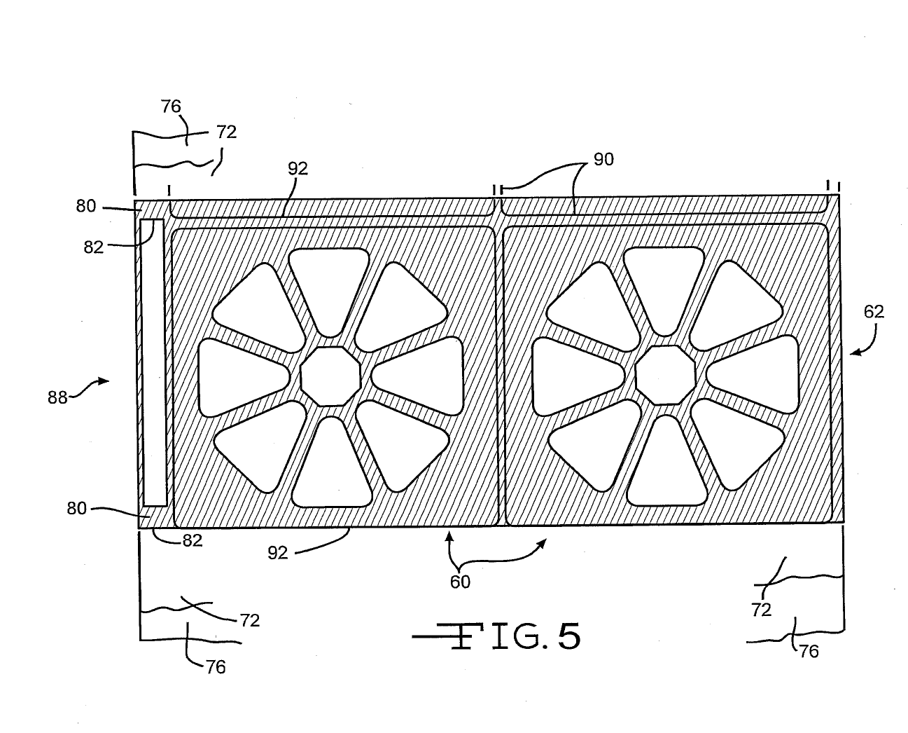

The sealing lid 20 must be precisely manufactured to alleviate problems of adhesive exposure to the contents of tray compartments 12. This is accomplished by the following procedure. Referring to FIG. 4, in this particular embodiment, a roll 70 of pressure sensitive material includes a liner 76 and a sheet of face stock material 72. An adhesive 74 is pattern coated in multiple columns across a web on the under side of the sheet of face stock 72. The adhesive 74 is between the face stock and liner and is represented by the crosshatches in FIG. 4. As used in the industry and in this specification, pressure sensitive material comprises a face stock with pressure sensitive adhesive covered by a liner. Prospective lid pattern die cut lines 90 which will form the edges 29 of the lids 20 are illustrated in FIG. 4 for clarity, but the actual die cuts are not on the roll of pressure sensitive material 70 at the time the face stock is pattern coated or flood coated with pressure sensitive adhesive.

The adhesive is in a pattern that allows the face sheet and adhesive to be die cut and slit to a desired number across the web based on the finishing equipment requirements typical to the industry and the desire tray configuration. The face stock 72 can be a moisture-proof material such as polypropylene, foil, polyester, vinyl, etc. The face stock 72 preferably is opaque so that the contents of the trays, which are to be sealed, will not be visible, but a non opaque or clear face stock 72 may be preferred for certain uses.

Patterns of pressure sensitive adhesive 74 are applied to the underneath side of the face stock 72 in a manner well known in the art, such as with a gravure process, for example. The adhesive 74 may be permanent or removable and of any type which meets the peel resistance specifications for a particular tray 10 application. The adhesive 74 can have any pattern suitable for use with any particular tray design.

Patterns can also be created within a flood coat of pressure sensitive adhesive 74 applied to the underneath side of the face stock 72 by separating the face stock from the liner 76, printing a pattern of blocking or deadening agent on top of the adhesive 74, and then reattaching the liner 76 to the adhesive. The adhesive blocking or deadening agent can have any pattern suitable for use with any particular tray design.

A silicone release liner 76 is secured to the exposed pattern of adhesive 74. The liner may be formed from paper, polyester, etc. and contain a silicone release coating to allow the face stock with adhesive to be removed from the liner and applied to the tray.

The roll 70 of pressure sensitive material illustrated in FIG. 4 has parallel edges 71 and a width substantially equal to four columns 60 of the lids shown. Of course, the roll 70 could be of any width that can be accommodated by the equipment to be used for die cutting the face stock 72, applying the adhesive 74, etc. The roll 70 may have a length, which can accommodate any number of lids in a column, again dependent on the equipment to be used. Each column 60 of lids in the roll 70 may include hundreds or thousands of rows of lid patterns, only three of which are shown in FIG. 4.

In addition to the specific adhesive lid patterns illustrated, the adhesive 74 includes sensor or registration marks 80. The registration marks 80 are applied to or formed on the face stock 72 simultaneously while either applying the patterned adhesive or while deadening portions of the flood coated adhesive as described herein. In a preferred embodiment, each registration mark 80 has a width 81 and a length 83 of approximately one-quarter inch, but neither the width 81 nor the length 83 is critical. Each registration mark 80 has a leading edge 82, which is critical. Each leading edge 82 is used to precisely position the face stock 72 for die cutting so that the pattern of adhesive 74 is precisely positioned on the face stock in relationship to the outer periphery or edge 29 of the lid 20 created by the die cut. The registration marks 80 extend in a column along the length of the roll 70 adjacent a roll edge 71 and between the roll edge 71 and the columns of patterns 60. The column of registration marks 80 is parallel to the columns of patterns 60, with one registration mark 80 for each row of patterns; however, there could be one registration mark for any number of rows of patterns. As will be explained herein, the location of the column with the registration marks can be placed anywhere within the pattern as long as the sensor marks are the only part of the pattern within the column.

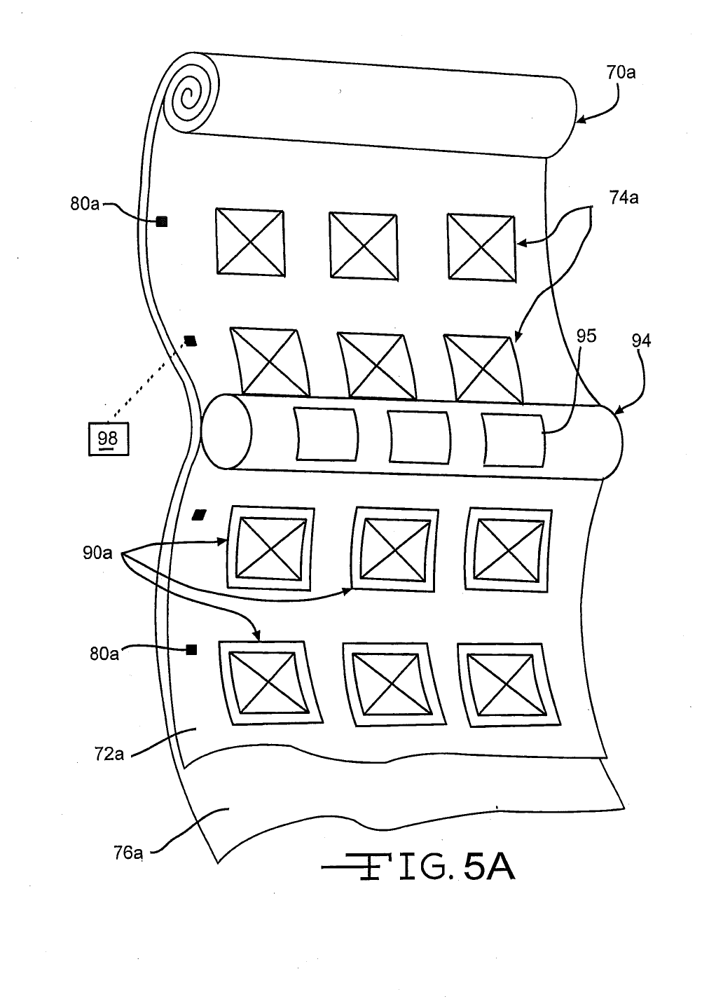

The roll 70 may be divided into smaller rolls 88 (FIG. 5) as necessary or desired to accommodate any particular die cutting equipment. Slit lines 78 designate the lines for slitting the roll 70 into such narrower slit rolls 88. A column of registration marks 80 is required for each slit roll 88. In the embodiment of FIG. 4, the roll 70 includes four lid pattern columns 60. Two slit lines 78 provide the two smaller slit rolls 88 of FIG. 5, each having a width including two lid columns 60. Therefore, roll 70 includes a set of registration marks 80 for each of the two columns of lid patterns in the slit rolls 88. Of course, if the roll 70 is slit into rolls having only one column of patterns, a set of registration marks 80 is required for each column. The width of the slit roll is equipment dependent and could be wide enough to accommodate any number of lids, such as one, two, three, etc.

FIG. 5 illustrates a row 62 of two lid patterns of the roll 88. As in FIG. 4, the adhesive 74 is between the face stock and liner and is represented by cross-hatching and the prospective lid pattern die cut lines 90 are illustrated for clarity only. To create the sealing lids 20, the slit roll 88 is fed into a die cutter (FIG. 5A) in an automated process. A sensor (FIG. 5A) such as a camera, laser, infrared sensor, etc. detects the position of each row 62 of patterns in the adhesive relative to the die cutter using the leading edge 82 of each registration mark 80 for the row. The position of the row 62 of adhesive patterns in the columns 60 is checked for each row 62 before cutting. A single registration mark 80 is required to be used for alignment proposes for each row 62 to be die cut, but additional registration marks could be used as well for each row 62 or each lid pattern or a single registration mark 80 could be used for multiple rows of die cut lidding.

In the embodiment of FIG. 5, a die cutter will cut the face stock 72 of the slit roll 88 along lines 90 to create the general shape of the lids 20. The registration mark leading edge 82 will be aligned with a leading edge 92 or die cut line 90 of the face stock 72, but this is not essential. Face stock leading edge 92 will form an edge 29 of the lid 20. The die cutter simultaneously cuts and perforates any desired intermediate locations on the face stock 21, such as cuts 31 and scores 32 (FIG. 3). After the face stock cuts and perforations are made, the portion of the face stock and adhesive that is outside of the die cut lines, called the ladder or matrix, will be removed from the roll 88. The roll 88 may be slit again into smaller rolls having a single column of lids, again depending on the equipment used to apply the lids to trays. It will be apparent to those skilled in the art that complex patterns such as shown in FIGS. 4 and 5 would be very difficult to use as registration marks because, wherever a sensor could be positioned, the path parallel to the roll edges 71 would include multiple pattern compartment edges.

The leading edges 82 of the adhesive registration marks 80 are detectable by sensors for positioning relative to the die cutter. The registration marks are detected by the sensor through either the face stock or the liner. Various types of sensors may be used to detect the adhesive registration marks 80. Any adhesive may be used with an appropriate sensor. The adhesive 74 may include a coloring agent, such as an ink or dye which will facilitate detection by a typical sensor. Of course, any detectible color may be used, but darker colors are more readily detectable. Another alternative is a fluorescing agent, which may be added to the adhesive or to a deadening agent, making the adhesive or deadening agent detectable by a photo sensor under a black light. Another alternative is an adhesive with no ink, dye, fluorescing agent or other additive, so long as an appropriate sensor is used to detect a sensor mark within the adhesive pattern. Preferably, all of the adhesive 74 is detectable by a sensor, but only the leading edge of the registration mark is critical.

FIG. 5A illustrates the die cutting method to accurately form the lids 20. A roll 70a consisting of liner 76a, and face stock material 72a is pattern coated with pressure sensitive adhesive 74a (on the underside of the face sheet 72a) to form columns of package lid patterns 74a and sensor or registration marks 80a. Alternatively, the patterns and registration marks can be formed by printing an adhesive blocking or deadening agent on top of pressure sensitive adhesive that has been flood coated on the face stock. With either method, the adhesive or adhesive blocking or deadening agent contains some type of sensing agent, such as a coloring or fluorescing agent, that allows the sensor mark in the pattern to be detected by a sensor. If the adhesive pattern is not created with a coloring or fluorescing agent then an appropriate sensor must be used to detect the pattern.

A sensor 98 reads the position of the registration marks 80a in relation to a die cutter 94. The die cutter 94 has cutting blades 95 for cutting the package lids. The registration marks 80a are used to precisely align the die cutter 94 to make precise die cuts 90a in the face stock 72a in an exact relationship to the location of the patterns 74a created by the pressure sensitive adhesive. The roll 70a is appropriately aligned with the die cutter 94 so that the lid cuts are made precisely around each package pattern 74a.

As previously indicated, the location of the column of adhesive formed registration marks can be placed anywhere on the face stock within or outside of the lid patterns, i.e. within the die cut lines of the lid, so long as the sensor marks are the only part of the pattern within the column. FIG. 5B illustrates alternative registration or sensor mark positions 80b and 80c. A roll of sealing lid blanks 70b is formed from a liner 76b and a face stock 72b having lid patterns 74b defined by a pressure sensitive adhesive. The roll 70b includes two columns of patterns 84 and 86 (only one pattern of each column is shown in FIG. 5B). Roll 70b is shown in FIG. 5B having a row including two patterns 74b. Only one registration mark is required, but alternative registration mark positions 80b and 80c are shown.

Registration mark 80b is shown abutting a bare or deadened area 85 of the pattern. Registration mark 80b lies in a column 81b, which is spaced from the column of patterns 74b, relative to the width of the roll, such that a sensor reading any marks in column 81b will read only the mark 80b. Registration mark 80c is shown in another location within the prospective cut line of the pattern, i.e. within the area of the lid to be cut. Registration mark 80c lies in a column 81c spaced from the column of patterns 74b, relative to the width of the roll, such that a sensor reading any marks in column 81c will read only the mark 80c. These alternative locations may not be preferred for certain applications, as the registration marks 80b and 80c will exist in the finished lid and may create a non-adhesive spot on the lid.

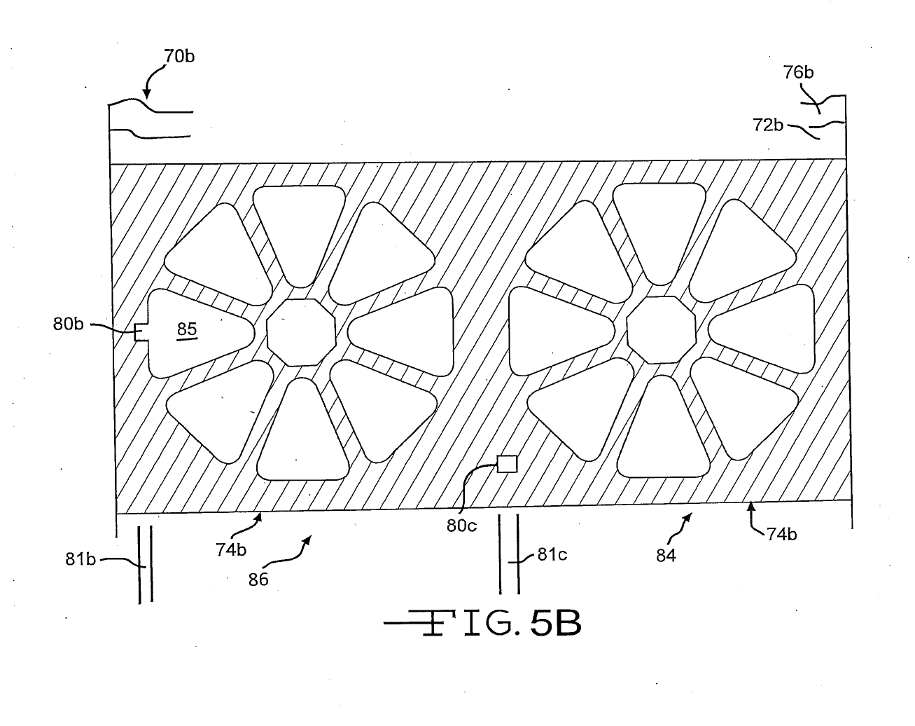

Referring to FIG. 6, a second embodiment of a sealing lid 120 is made using the present invention. The lid 120 includes a face stock 121, an adhesive layer 122, and a liner 123. The lid 120 is sized and shaped to fit the tray 10. To manufacture the sealing lid 120, the face stock 121 is provided, typically in a continuous roll. The adhesive 122 is applied across the entire surface of the face stock 121. The liner 123, typically in a continuous roll, is then applied to the adhesive 122. After the liner 123 is applied, a die cutting machine (not shown) is used to cut the liner 123 along cut lines 123a, which correspond to the shapes of compartments 12 and indentation 14 of the tray 10. The face stock 121 is also die cut and perforated to a specific registration with the die cut liner, as desired for example, as shown in FIG. 3.

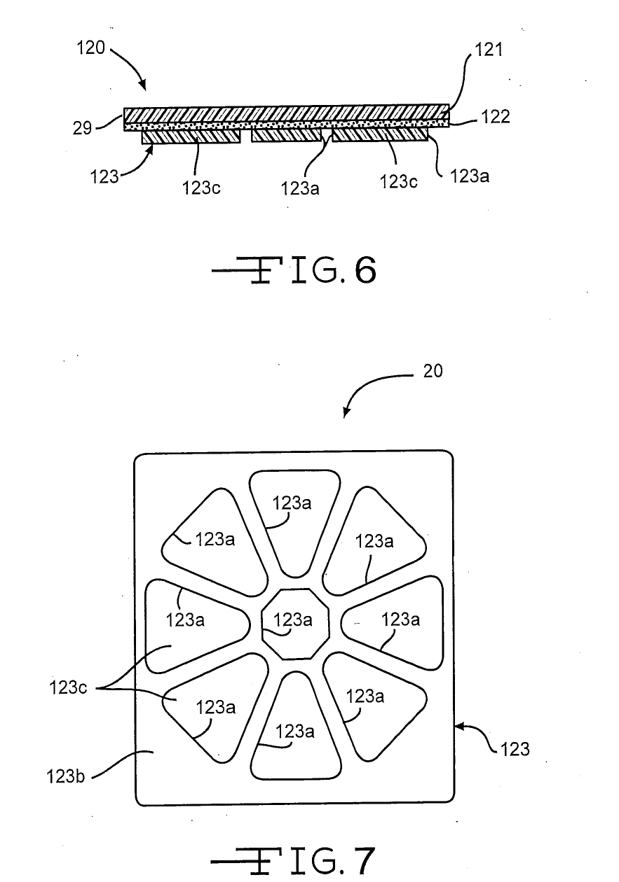

Referring to FIG. 7, in the process of applying the lid 120 to a tray 10, the liner portion 123b is removed from the lid 120. This exposes the adhesive 122 previously underneath the liner portion 123b in a pattern corresponding to the top surface 11 of the tray 10. The eight generally triangular liner sections 123c remain adhered to the face stock 121. The lid 120 is then applied to the tray 10, with the exposed adhesive 122 contacting the top surface 11 of the tray 10 at the locations of the tray ribs 15, 16 and the outer peripheral region 18. The liner sections 123c are positioned over the compartments 12 and indentations 14 to provide an adhesive block to shield any compartment contents from the adhesive.

To accurately form the lid 120, the liner 123 must be precisely die cut, in relationship to the die cut of the face stock. This is accomplished by printing a registration mark on either the top side of face stock 121, the bottom side of the liner 123, or on the adhesive 122. The registration mark may be formed from adhesive in a manner similar to that shown in FIGS. 5 and 6 of the first embodiment, the only difference being that the pressure sensitive adhesive printed on the back of the face stock 121 will have no lid pattern. Accurate positioning of the liner cut lines 123a can be accomplished by positioning a blank for the lid 120 relative to the die cutter in the same manner as in the first embodiment. The registration mark is used to precisely align the die cut of the sealing lid 120 within the die cutting machine to make the cuts 123a in the liner.

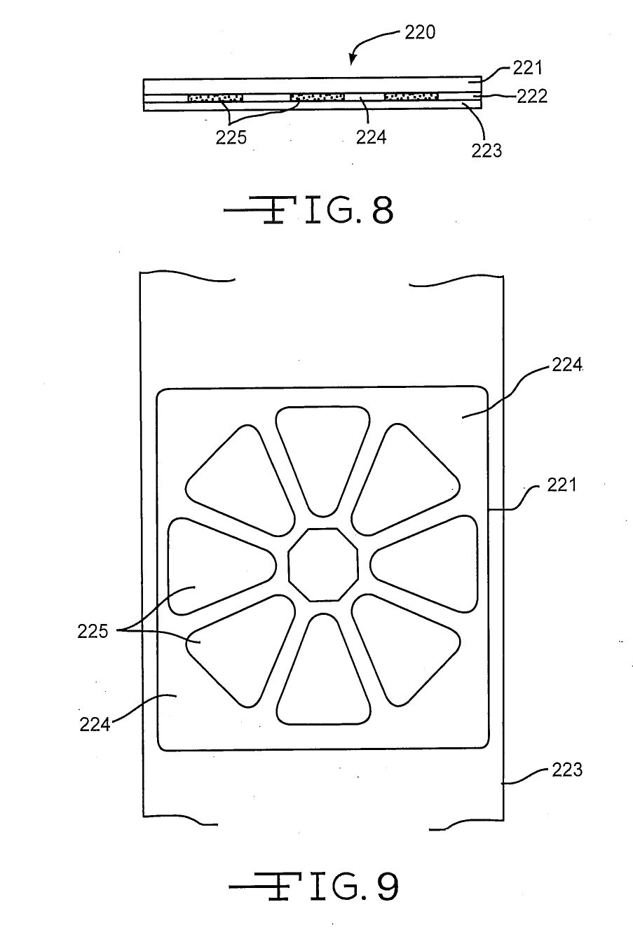

Referring to FIG. 8, a third embodiment of a sealing lid 220 is made using the present invention. The lid 220 includes a face stock 221, an adhesive layer 222, and a liner layer 223. The lid 220 is sized and shaped to fit the tray 10. To manufacture the sealing lid 220, a continuous roll of face stock material is provided with an adhesive layer 222, such as a pressure sensitive adhesive, applied across the entire surface of the roll, and covered by a liner 223. The liner is separated from the adhesive layer 222 and an adhesive block in the form of an adhesive deadener 225, such as an ink or varnish or other chemical deadener that contains a coloring or fluorescing agent that is used to identify the location of the pattern, is then applied to the adhesive in patterns that correspond to the shapes of compartments 12 and indentations 14 of the trays 10, leaving unblocked portions of adhesive 224 active. The liner 223 is then reattached to the adhesive layer 222. Multiple rows and columns of patterns may be formed on the roll of face stock material, similar to those shown in FIGS. 4 and 5. The face stock 221 also may be cut and perforated as desired, for example, as shown in FIG. 3. Registration marks similar to registration marks 80 on the previously disclosed embodiment can be provided on the adhesive 222 and defined by a leading edge between the active adhesive and deadened or inactive adhesive created by an adhesive block or deadening agent that contains a coloring or fluorescing agent which is used to identify the location of the pattern.

Referring to FIG. 9, after the face stock 221 is die cut and the excess face stock material is removed from the liner 223, the liner 223 is removed from the remaining face stock 221 as the lid 220 is being applied to a tray 10. This exposes the active adhesive 224. The voided, blocked, inactive or deadened adhesive portions 225 remain on the face stock in the shape of the tray openings. As the liner 223 is being removed from the lids 220, the lids 220 are applied to the trays 10, with the exposed active adhesive 224 contacting the top surfaces 11 of the trays 10 at the locations of the tray ribs 15, 16 and the outer peripheral regions 18. The voided, blocked, deadened or inactive adhesive portions 225 are positioned over the compartments 12 and indentations 14.

The principle and mode of operation of this invention have been explained and illustrated in its preferred embodiments. However, it must be understood that this invention may be practiced otherwise than as specifically explained and illustrated without departing from its spirit or scope.

What is claimed is:

1. A method of making lids for sealing a package comprising the steps of :
providing a roll of face stock material, the roll having a length and a width, the width defined by generally parallel edges extending the length of the roll,
providing a column of package patterns on the face stock material, the column of package patterns extending along the length of the roll, each package pattern formed by an adhesive, and
providing a column of registration marks on the face stock material, the column of registration marks extending along the length of the roll and generally parallel to the column of package patterns, each registration mark formed by the adhesive.

2. The method of making lids as defined in claim 1 wherein the column of package patterns and the column of registration marks are provided on the face stock material simultaneously.

3. The method of making lids as defined in claim 1 wherein the column of registration marks is spaced along the width of the roll from any adhesive forming a portion of any package pattern.

4. The method of making lids as defined in claim 1 wherein each registration mark has a leading edge substantially perpendicular to the length of the roll and the roll edge.

5. The method of making lids as defined in claim 1 wherein the adhesive includes a sensing agent comprising a coloring agent or a fluorescing agent.

6. The method of making lids as defined in claim 1 wherein each registration mark of the column of registration marks corresponds to a package pattern of the column of package patterns.

7. The method of making lids as defined in claim 1 wherein further comprising the step of sensing the location of each pattern on the face stock in relation to a registration mark, and die cutting the package patterns on the roll.

8. The method of making lids as defined in claim 1 wherein the adhesive is a pressure sensitive adhesive.

9. The method of making lids as defined in claim 1 wherein the step of providing a column of package patterns comprises the step of deadening or deactivating a portion of adhesive on the face stock material.

10. The method of making lids as defined in claim 1 wherein portions of the adhesive include a deadening or deactivating agent, the deadening or deactivating agent including a sensing agent comprising a coloring agent or a fluorescing agent.

11. The method of making lids as defined in claim 1 wherein the adhesive includes no coloring or fluorescing agent, and further comprising the step of sensing the registration marks with a sensor which can detect the sensor marks or adhesive patterns without a coloring or fluorescing agent.

12. The method of making lids as defined in claim 1 further comprising the step of applying a liner of sheet material covering the column of package patterns, whereby the adhesive is between the face stock and the liner, wherein the liner is releasibly attached to the adhesive.

13. The method of making lids as defined in claim 1 wherein the package patterns are formed by an active adhesive applied to the face stock.

14. The method of making lids as defined in claim 1 wherein the package patterns are formed by an adhesive deadener applied to a face stock substantially entirely coated by an active adhesive.
